(19) United States
(12) Patent Application Publication
(10) Pub. No.: US 2006/0032705 A1
(43) Pub. Date: Feb. 16, 2006

(54) Lightweight composite ladder rail having supplemental reinforcement in regions subject to greater structural stress

(76) Inventors: William R. Isham, Alpine, UT (US); Stephen N. Webber, Cedar Hills, UT (US); James Llechty, Fremont, CA (US); A. Brent Strong, Sandy, UT (US)

Correspondence Address: Angus C. Fox, III, 4093 N. Imperial Way, Provo, UT, 84604-5386, US

(21) Appl. No.: 10/919,420

(22) Filed: Aug. 16, 2004

(51) Int. Cl. E06C 7/00

(52) U.S. Cl. 182/46

(57) ABSTRACT

A molding process, other than pultrusion, is used to manufacture composite ladder rails of non-uniform cross-sectional area and non-uniform strength throughout their lengths. Each ladder rail includes a structural fiber preform embedded in a cured polymeric resin. Fiberglass preforms are preferred because they are electrically non-conductive. Resin transfer molding processes, using either polyester or epoxy resins, are ideally suited for such manufacture. Vacuum-bagged, open-mold processes may also be used, as may be compression molding processes. Regions of the rails subject to greater stress during usage are strategically reinforced with additional structural fibers, and have greater cross-sectional area than regions subjected to lesser stress. The differential cross-sectional area permits the construction of ladders which are optimized for both strength and lightness of weight. Ladders of all types may be constructed with rails incorporating the invention.

### BACKGROUND OF THE INVENTION

1. Field of the Invention

This invention relates to ladders, to rails used in the manufacture of ladders and, more particularly to molded composite ladder rails.

2. Description of the Prior Art

The use of portable ladders throughout history is well documented. Today, portable ladders are made not only of wood, but of aluminum alloys and composites using a variety of structural fibers.

Usually manufactured from spruce, wood ladders are relatively lightweight and inexpensive. As long as they are dry, they are safe for use around electricity. Wood ladders, though, have a number of drawbacks. Solid (i.e. non-laminated) pieces of wood used in the construction of ladders may have latent defects which can cause a structural failure. Wood is also subject to gradual, debilitating deterioration by moisture, sun, insects and microorganisms. Furthermore, expansion and contraction of wood caused by temperature and humidity changes can result in a gradual loosening of steps and braces, which requires frequent maintenance. Wood ladders also tend to be less stable in larger sizes.

Though aluminum alloys offer a high strength, lightweight alternative to wood, ladders made of aluminum alloys also have a number of drawbacks. Certain chemicals and salt water environments can corrode and weaken aluminum ladders. Although having excellent uniformity in the strength of structural members at the time of manufacture, the rails of aluminum ladders are easily bent and cracked. The most significant drawback is that aluminum is the third-best conducting metal. This attribute makes aluminum ladders extremely dangerous for work anywhere near high-voltage electrical wires. Historically, metal ladders have been the choice when electrical contact is not anticipated. Unfortunately, a ladder coming into contact with an electrical wire often occurs by accident. Therefore, a risk of electrocution may exist even when care is taken to avoid known and visible hazards. The problem is compounded because the light weight and high strength characteristics of metal ladders may be an inducement for their use even when electrical safety is a concern.

Though generally somewhat heavier and more expensive than aluminum ladders of the same size and rating, ladders having fiberglass composite rails joined with aluminum rungs have become extremely popular because they combine the best physical qualities of aluminum and wood ladders. The fiberglass composite rails will not conduct electricity. They are also very corrosion resistant. With minimal care and maintenance, fiberglass ladders can last generations.

Aluminum ladder rails are typically manufactured using an extrusion process. Fiberglass composite ladder rails, on the other hand, are typically manufactured using a pultrusion process. Pultrusion is a technique whereby longitudinally continuous fibrous materials are soaked in a resin bath and pulled through a heated die so that the resin sets and produces a rigid part downstream of the die. Both the extrusion process for aluminum rails and the pultrusion process for fiberglass composite rails produce rails of uniform cross section throughout their lengths. FIG. 1 shows a typical ladder rail 101 of uniform cross-sectional area throughout its length. The rail of FIG. 1 has a flattened C-shaped cross-section, and has been punched with a plurality of apertures 102. One end of a rung can be inserted in an aperture and anchored to the rail by mechanically swedging the rungs to the rails. The opposite end of the rung can be inserted in the aperture of a parallel rail and secured thereto in a like manner. Alternatively, each end of a rung can be welded or swedged to an attachment bracket that is either riveted or screwed to the ladder rail.

The greatest weakness of the composite pultrusion and aluminum extrusion manufacturing processes is that the cross-sectional profile of the rail must remain constant throughout its entire length. During use, a ladder rail is subjected to different levels of stress, torque, shear, flex and abuse in different regions along its length. Therefore, if the rail needs more strength in a particular region, material must be added to the entire length of the rail. Thus, a ladder rail of uniform cross section throughout its length is necessarily overly strong and heavy throughout much of its length, while those regions subjected to maximum stress, torque, shear, flex and abuse are designed to be just strong enough to support the maximum rated load—plus an additional safety factor load—without failure, under expected usage conditions. Consequently, all ladders having rails of uniform cross section throughout their lengths are considerably heavier than they need to be. Neither the extrusion process nor the pultrusion process is readily adaptable to the manufacture of rails of non-uniform cross section over their lengths. This non-optimum condition has heretofore been considered acceptable in the interest of minimizing manufacturing costs. Although there has always been an effort to design air and water craft so that no portion of a aircraft, ship or boat is any stronger than it needs to be, in order to minimize unloaded weight and thereby maximize payload and/or performance of the craft, the concept has been largely ignored by manufacturers of ladders.

Today, the need for ladders that are light in weight and that can be safely handled by an individual working alone is of greater significance than the need for ladders which have a low initial purchase price. The purchase price is likely only a tiny fraction of the total costs related to treating and compensating potentially career-ending physical injuries sustained while carrying, loading, unloading, setting up, and taking down a conventional ladder over its useful life. This is especially true when the number of persons working in trades that require the frequent use of a portable ladder, who are nearing retirement age, who have either a small stature or a history of previous injuries related to the lifting and carrying of heavy objects, is taken into consideration. Utility workers, electricians, construction workers and telecommunication installers, in addition to homeowners and those in many other industries, could benefit from the availability of ladders-especially extension ladders-which are significantly lighter than those of the same ratings and sizes currently available.

### SUMMARY OF THE INVENTION

The present invention provides a process for manufacturing ladder rails of non-uniform cross-sectional area throughout their lengths. Regions of the rails subject to greater stress during usage are reinforced with additional structural fibers and, consequently, have greater cross-sectional area than regions subjected to lesser stress. Although the concept of strength and weight optimization has long been used in the design of air and water craft, the concept is foreign to manufacturers of ladders.

Structural fibers of many types may be used. Use of the following fibers is presently contemplated: glass (types E, S, S2, A or C), quartz, poly p-phenylene-2,6-bezobisoxazole (PBO), basalt, boron, aramid fibers such as Nomex® and Kevlar® (poly-para-phenylene terephthalamide), ultra-high-molecular-weight polyethylene, carbon, graphiteand fiber hybrids such as carbon/aramid and carbon/glass. For ladders used near electrical circuits, non conductive fibers are mandatory. Type E glass fibers have excellent dielectric properties and are the most commonly used structural fiber. However type S and S2 glass fibers have greater strength. Quartz fibers, while more expensie than glass, have lower density, higher strength and higher stiffness than E-glass, and about twice the elongation-to-break, making them an excellent choice where durability is of paramount importance. Boron fibers, which are five times as strong, twice as stiff as steel, and non-conductive, are also ideal for structural fiber reinforcement of ladder rails.

The ladder rails are fabricated using a molding process other than pultrusion. High-pressure injection molding, resin-impregnated fiber molding, compression molding, resin transfer molding, and vacuum-assisted molding are processes which may be used to implement the present invention. High-pressure injection molding is suitable for use with both thermoset and thermoplastic resins. Compression molding is used for thermoset materials, and generally requires an expensive, two-part precision closed mold. A resin transfer molding, or RTM, process is currently considered to be the preferred molding method for quantity production of ladder rails produced in accordance with the present invention. Although originally developed in the mid 1940s, the RTM process met with little commercial success until the 1960s and 1970s, when it was used to produce commodity goods like bathtubs, computer keyboards and fertilizer hoppers. The automotive industry has now used RTM for several decades. Traditional RTM is a fairly simple process: both parts of a two-part, matched, closed mold are fabricated from metal or composite materials. Alternatively, one part of a two-part compression mold is fabricated from metal or composite material, and a second part is fabricated from a compressible rubber material. A dry structural fiber reinforcement, called a preform, is preshaped or layed up and oriented into a skeleton of the actual part. The preform is placed in the mold and the mold is closed. Resin and an initiator compound (catalyst) are metered and mixed in dispenser equipment, then pumped into the mold under pressure through injection ports, from where it follows predesigned paths through the preform. Air in the mold is displaced and escapes from vent ports placed at strategic points in the mold cavity. During this injection stage, the resin wets the fibers. For resins which are cured (i.e., solidified) via cross-linking or polymerization induced by the addition of a chemical initiator to the resin, no heat need be applied to the mold. Some thermosetting resin mixes, on the other hand, must be subjected to both heat and pressure in order to harden. However, even for resins which set up when mixed with an initiator, heat is often applied to the mold to speed up the cross-linking or polymerization process in order to maximize product flow through the mold. Once the molded part develops sufficient green strength to handle, the mold can be opened and the part removed. Green strength refers to the strength of a part before it has completely cured. Typically, when a part is removed from the mold, it is still warm and still reacting. Thus, complete cross-linking or polymerization of the resin occurs after the part is removed from the mold. As molds are generally expensive, parts may be removed from the mold while still green in order to maximize utilization of the mold. With vacuum-assisted resin transfer molding (VARTM) using a vacuum-bagged open mold, the preform is typically wrapped around a mold block. The mold block and preform are enclosed in a sealable bag. Catalyzed resin is introduced on one side of the mold block and air is extracted on the other side. The partial vacuum pulls the resin through the preform to create the part. Once the resin sets up, the completed part is removed from the mold block.

RTM can also be done with thermoplastic resins. In this case, the resin is heated above its melting point and then injected into the mold cavity. The resin wets the fibers and then cools to solidify. Other operations are generally analogous to those described for thermoset resins.

### BRIEF DESCRIPTION OF THE DRAWINGS

FIG. 1 is an isometric view of a prior art composite ladder rail of uniform cross-sectional area throughout its length;

FIG. 2 is an isometric view of a composite ladder rail for the base section of a non-self-supporting extension ladder, the rail having non-uniform cross-sectional area throughout its length;

FIG. 3 is an enlarged view of region 3 of the isometric view of FIG. 2;

FIG. 4 is an enlarged view of region 4 of the isometric view of FIG. 2;

FIG. 5 is an enlarged view of region 5 of the isometric view of FIG. 2;

FIG. 6 is an isometric view of a composite ladder rail for a self-supporting step ladder, the rail having a first reinforced region at a base end and a second reinforced region at hinged connection end;

FIG. 7 is an enlarged view of region 7 of the isometric view of FIG. 6;

FIG. 8 is an enlarged view of region 8 of the isometric view of FIG. 6;

FIG. 9 is a cross sectional view of the ladder rail of FIG. 7, taken through section line 9-9;

FIG. 10 is a cross-sectional view of closeable mold for a composite ladder rail in an opened configuration, taken through a region of of the mold designed for maximum rail thickness;

FIG. 11 is a cross-sectional view of the closeable mold of FIG. 10 following the insertion of a structural fiber preform;

FIG. 12 is a cross-sectional view of the closeable mold and inserted preform of FIG. 11 following the closing of the mold;

FIG. 13 is a cross-sectional view of the closed closeable mold and inserted preform of FIG. 12 during the injection of resin into the mold cavity;

FIG. 14 is a cross-sectional view of the mold of FIGS. 10-13, taken through a region of the mold designed for minimum rail thickness;

FIG. 15 is a cross-sectional view of the mold of FIGS. 10-13, taken through a region of the mold designed for intermediate rail thickness;

FIG. 16 is a top plan view of the cavity portion of the mold used to fabricate the rail portion of FIG. 9;

FIG. 17 is a graphic representation of the cotton or cotton/polyester veil fabric used to encapsulate the structural fiber preform;

FIG. 18 is a graphic representation of a second structural fiber layer, showing two sets of fibers, with fibers of the first set intersecting and interwoven with those of the second set, and with fibers of both sets oriented at a 45-degree-angle direction;

FIG. 19 is a graphic representation of a first structural cloth fiber layer, showing a majority of structural fibers running in a 0-degree-angle direction from one end of the rail to the other and a minority of structural fibers running in a 90-degree-angle direction; and

FIG. 20 is a cross-sectional view of a vacuum-bagged open mold and a four-layer structural fiber preform.

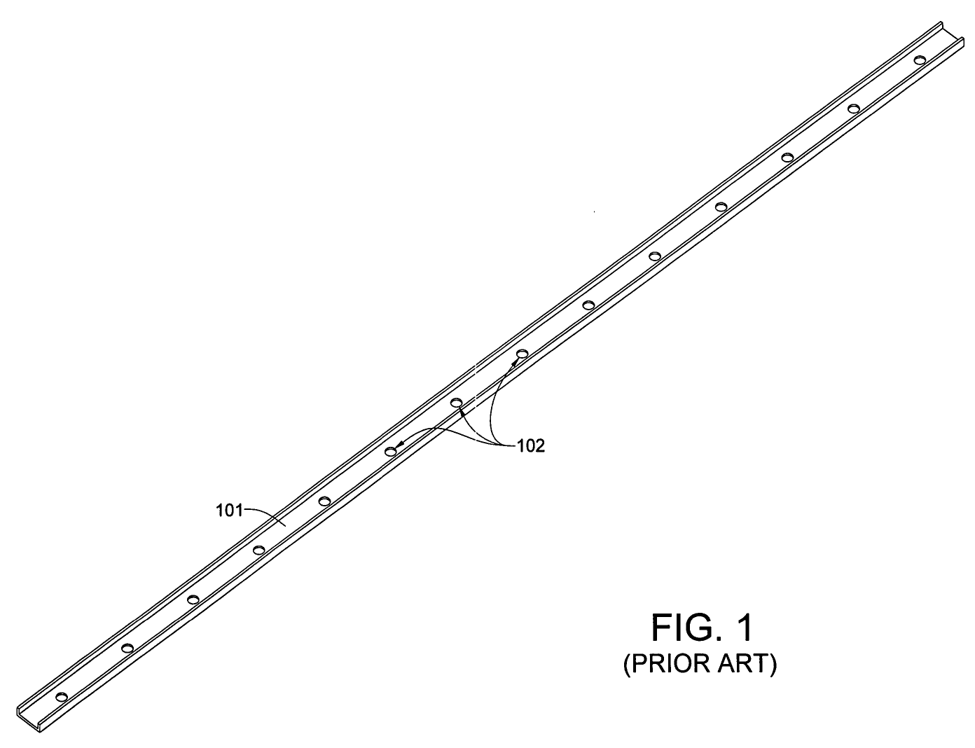

### DETAILED DESCRIPTION OF THE INVENTION

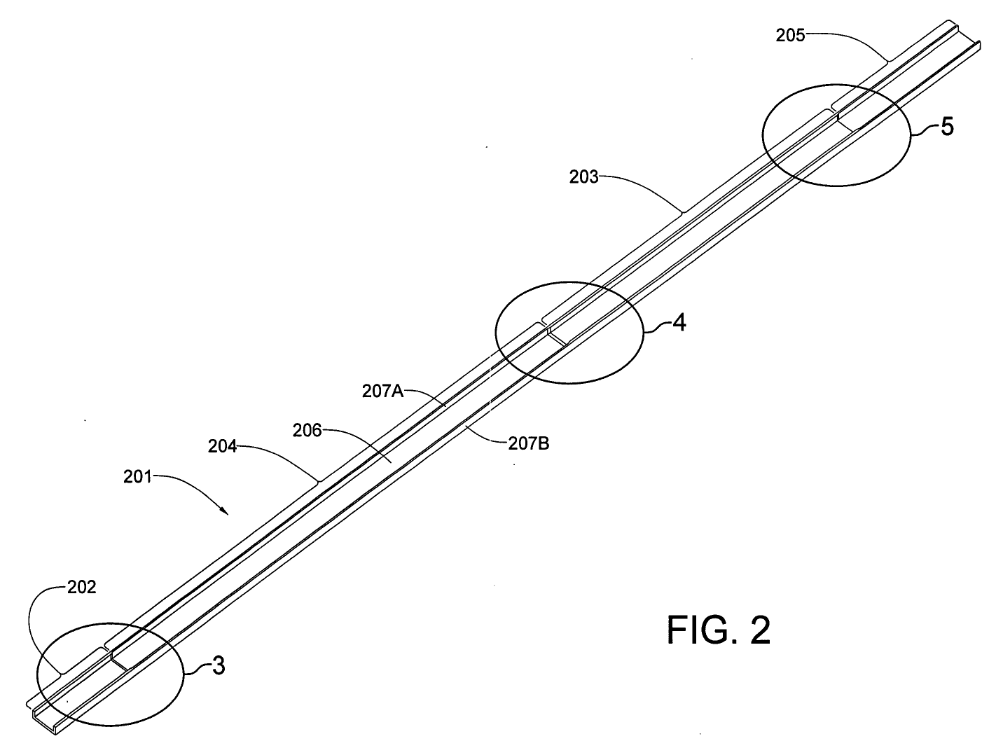

Exemplary ladder rails and the processes which may be used to manufacture the ladder rails will now be described in detail, with the reference to the attached drawing FIGS. 2 through 20. It is to be understood that the drawing figures are not necessarily drawn to scale, and that they are merely illustrative of the apparatus and processes. The main theme of the present invention is that a composite ladder rail may be supplementally reinforced in strategic locations for a variety of applications in one or more longitudinal regions by increasing the number of structural fibers in those regions, with a corresponding increase in the thickness of the rail and its cross-sectional area in the structurally-reinforced region. The technique of supplemental reinforcement in strategic locations can be applied to ladder rails used for a variety of applications, including, but not limited to, use in self-supporting step ladders, non-self-supporting extension ladders, and combination ladders. Structural fibers of many types may be used. Use of the following fibers is presently contemplated: glass (types E, S, S2, A or C), quartz, poly p-phenylene-2,6-bezobisoxazole (PBO), basalt, boron, aramid fibers such as Nomex® and Kevlar® (poly-para-phenylene terephthalamide), ultra-high-molecular-weight polyethylene, carbon, graphiteand fiber hybrids such as carbon/aramid and carbon/glass. For ladders used near electrical circuits, non conductive fibers are mandatory. Type E glass fibers have excellent dielectric properties and are the most commonly used structural fiber. However type S and S2 glass fibers have greater strength. Quartz fibers, while more expensie than glass, have lower density, higher strength and higher stiffness than E-glass, and about twice the elongation-to-break, making them an excellent choice where durability is of paramount importance. Boron fibers, which are five times as strong, twice as stiff as steel, and non-conductive, are also ideal for structural fiber reinforcement of ladder rails.

A molding process, other than pultrusion, is employed to manufacture the strategically structually reinforced rails. Such molding processes include high-pressure injection molding, resin-impregnated fiber molding, compression molding, resin transfer molding (RTM), using rigid closed mold or a combination hard and solf mold, and vacuum-asisted resin transfer molding (VARTM) using a rigid or flexible cover over a one-sided mold.

Using high-pressure injection molding, a structural preform is placed in a mold cavity, the mold closed, and a melted thermoplastic resin or uncured thermoset resin is injected into the mold cavity under high pressure, completely wetting the preform and assuming the shape of the mold cavity. After the injected material cools (in the case of the thermoplastic resin) or cures (in the case of the thermoset resin) and solidifies, the completed part can be removed from the mold cavity.

Using resin-impregnated fiber molding, a controlled amount of thermoset or thermoplastic resin is incorporated into a resin-impregnated structural fiber forms (commonly called prepregs) using solvent, hot-melt or powder impregnation technologies. Prepregs can be stored in an uncured state until used. The prepreg structural preform is placed in a precision closed mold and subjected to heat and pressure. In the case of thermoplastic resin, the resin in the preform melts, wetting the structural fibers. The melted resin fibers or particles assume the shape of the mold. After cooling or curing, a finished part is removed from the mold. In the case of a thermoset prepreg part, the preform is stored in a refrigerator until it is cured in a heated precision closed mold. heated precision closed mold.

Using compression molding, structural fiber layer is sandwiched between two layers of thick resin paste to form a sheet molding compound. A piece of the sheet molding compound is placed in a heated closed mold to which 500 to 1,200 psi of pressure is applied. Material viscosity drops and the sheet molding compound flows to fill the mold cavity. After cure, the mold is opened and the part removed. Though the compression molding process typically uses thermoset resins, it can also be used with thermoplastic resins.

Resin transfer molding (RTM), using a closed mold, is presently considered to be the preferred molding method for quantity production of ladder rails produced in accordance with the present invention. With RTM, both parts of a two-part, matched, closed mold are fabricated from metal or composite material. Alternatively, one part of a two-part compression mold is fabricated from metal or composite material, and a second part is fabricated from a compressible rubber material. After the dry fibers are placed in the mold, the mold is closed and the resin is then injected into the mold to wet the fibers and fill the mold. For thermoset resins, the mold can be heated to acclerate curing of the part, although that is not necessarily required if curing of the resin has been chemically initiated. For thermoplastic resins which are injected as a molten liquid, the injected material is simply allowed to cool to solidify after coating the fibers and filling the mold.

With vacuum asisted resin transfer molding, fiber reinforcements are placed in a one-sided mold and a cover, which may be either regid or flexible, is placed over the top of the mold to form a vacuum-tight seal. When using a flexible cover, which is typically an air impermeable bag, the flexible cover essentially forms the other side of the mold. Catalyzed resin is typically introduced through strategically located ports on one side of the mold, and a partial vacuum is applied to ports located on the the other side thereof. The partial vacuum extracts the air and pulls the resin through the preform to create the part. Once the resin sets up, the completed part is removed from the mold. Polyester; two-part epoxy, bismaleimide and polyetheramide resins are commonly used in the RTM and VARTM processes.

Referring now to FIG. 2, a first embodiment composite ladder rail 201 is shown that may be used in the fabrication of a base section of a non-self-supporting extension ladder such as the one that is the subject of U.S. Pat. No. 5,758,745 (the '745 patent) granted to Robert D. Beggs, et al. This patent is hereby incorporated by reference into the present application. The rail 201 has a flattened C-shaped cross-section, which is of non-uniform area throughout its length. The rail 201 has augmented cross-sectional area at the lower end 202, to which a hingeable foot will be attached in a conventional manner, and in a maximum and near-maximum extension overlap region 203. As the foot of the ladder is subject to impact abuse, it must be reinforced with additional structural fibers for added strength. The overlap region 203 must be reinforced in a like manner because of additional stresses applied to the rail and rail flanges 204A and 204B when the fly section (not shown) of the extension ladder is at or near maximum extension.

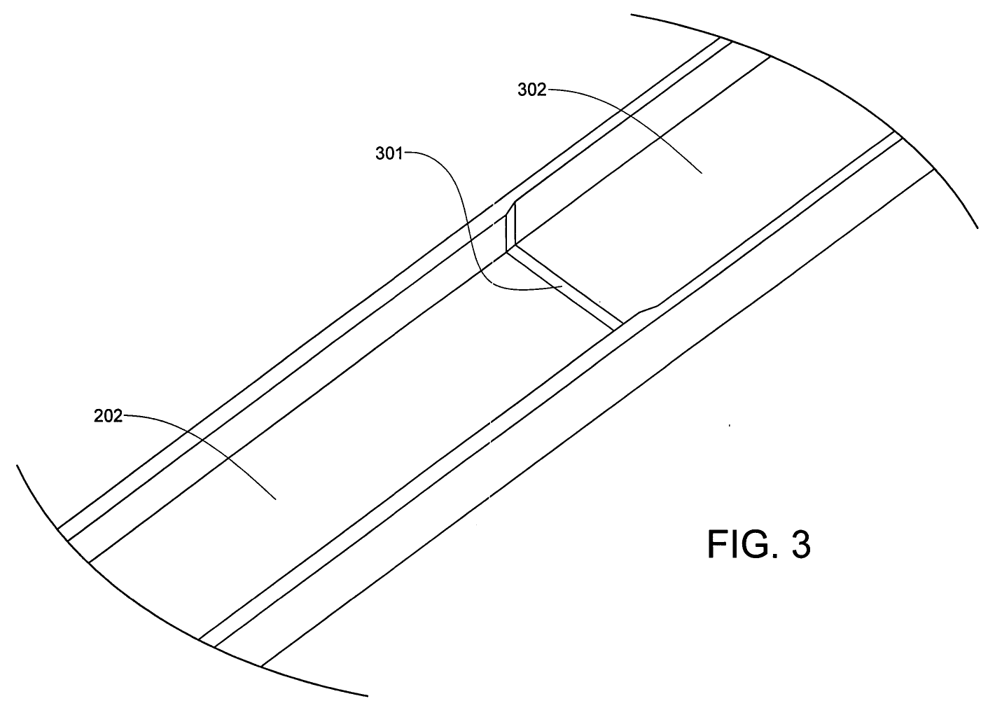

Referring now to FIG. 3, the detail of the structurally-reinforced lower end 202 of rail 201 is visible. It will be noted that there is a ramped transition region 301, rather than an abrupt transition between the lower end 202 and a central region of lesser cross-sectional area 302. The ramped transition 301 serves to reduce stresses where the lower end 202 meets the central region 302.

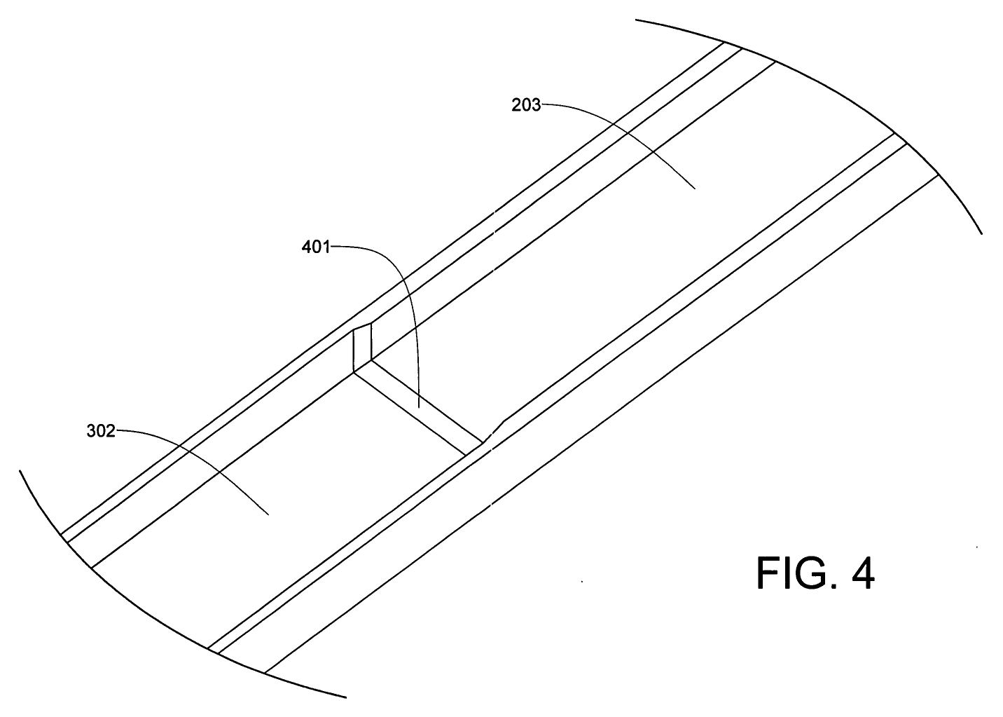

Referring now FIG. 4, a ramped transition region 401 between the central region of lesser cross-sectional area 302 and the extension overlap region 203 is visible in greater detail. The ramped transition 401 serves to reduce stresses where the central region 302 meets the extension overlap region 203.

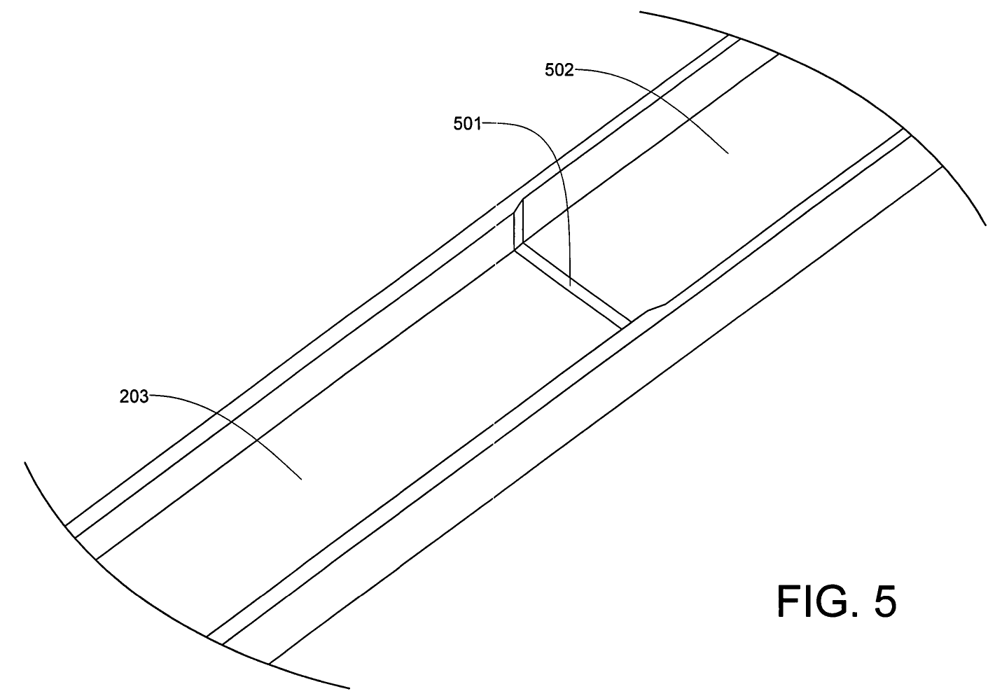

Referring now to FIG. 5, a ramped transition region 501 between the extension overlap region 203 and an upper end of lesser cross-sectional area 502 is visible in greater detail. The ramped transition 501 serves to reduce stresses where the extension overlap region 203 meets the upper end 502.

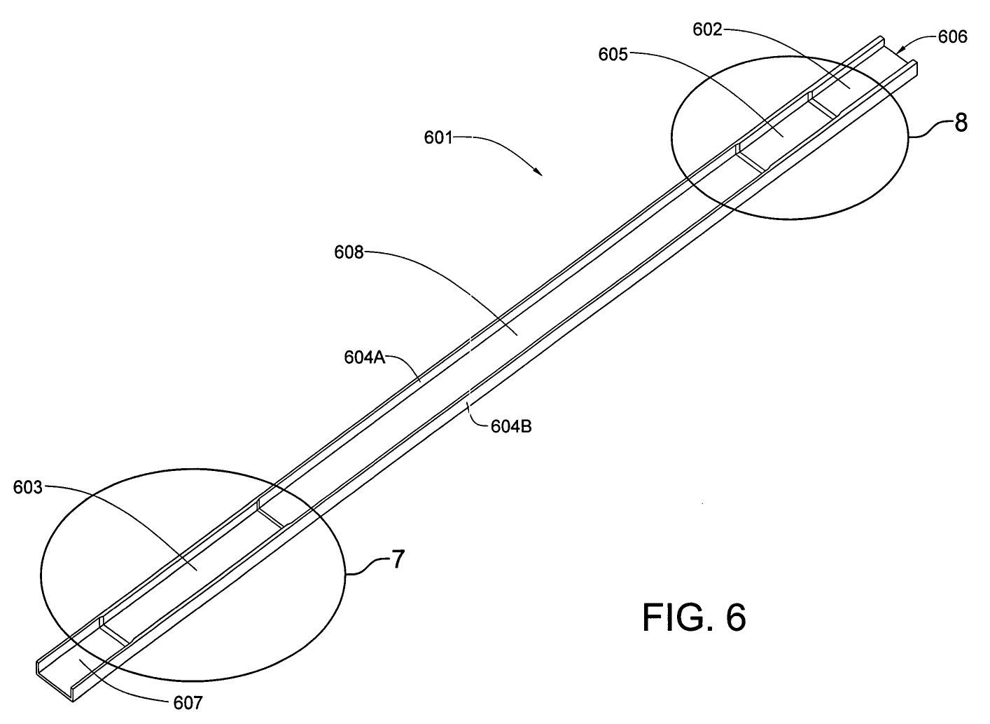

Referring now to FIG. 6, a second embodiment composite ladder rail 601 is shown that may be used in the fabrication of a self-supporting combination step and extension ladder such as the one that is the subject of U.S. Pat. No. 4,371,055 (the '055 patent) granted to Larry J. Ashton, et al. This patent is hereby incorporated by reference into the present application. The ladder of the '055 patent includes a pair of base sections, each of which is fabricated from a plurality of rungs interconnecting a pair of channeled outer side rails of molded fiberglass, and a pair of fly sections, each of which is fabricated from a plurality of rungs interconnecting a pair of inner side rails of molded of fiberglass. Each of the inner side rails is telescopically mounted within an outer side rail so that the inner side rails can be extended to increase the height of the ladder in either configuration. The two fly sections are hinged together at the top ends so that the ladder may be folded and unfolded from a step ladder configuration to a straight extension ladder configuration and vice versa. By incorporating four second embodiment rails 601 into the fly sections of the combination ladder of the '055 patent, the weight thereof can be substantially reduced. Still referring to FIG. 6, each second embodiment rail 601 is reinforced at the top end 602 where the hinges, which interconnect the fly sections, attach. The rail 601 is also reinforced in a lower overlap region 603 because of additional stresses applied to the rail base and rail flanges 604A and 604B when the base and fly sections of the combination ladder are at or near maximum extension. Reinforcement of the top end occurs in two steps, with region 605 being a transition region to the top end 602. Both the rail flanges 604A and 604B, as well as the rail back 606, are similarly reinforced. Regions 607 and 608 are of standard thickness and reinforcement.

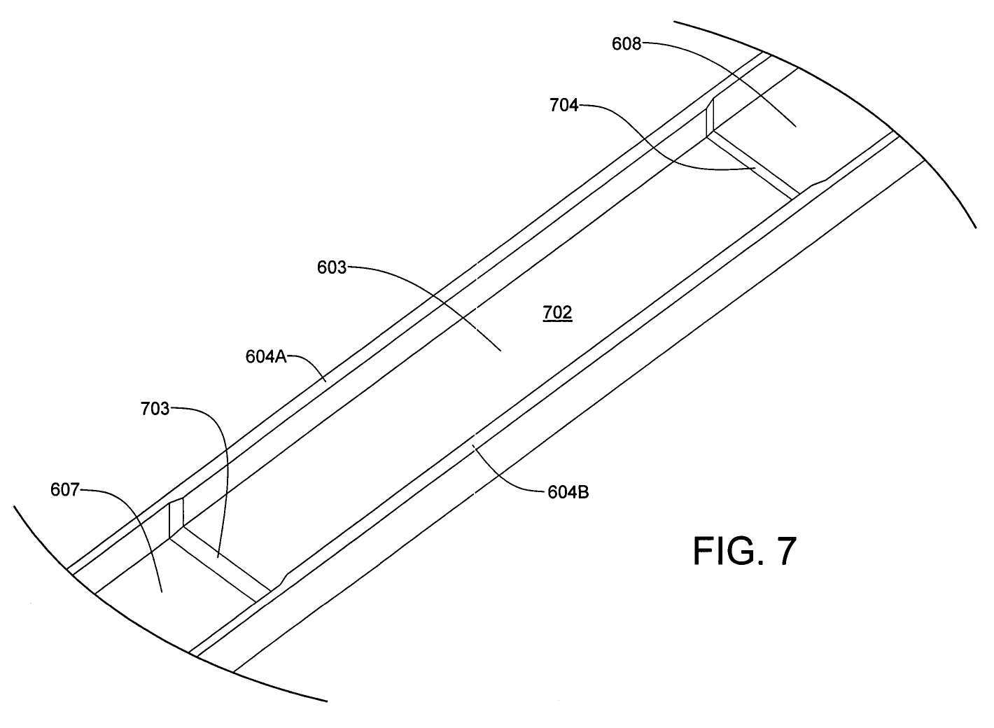

Referring now to FIG. 7, the details of the extension overlap region 603 are clearly shown. The ramped transitions 703 and 704 serve to reduce stresses where the extension overlap region 603 meets the lower region 607 and central region 608, both of which are of standard thickness.

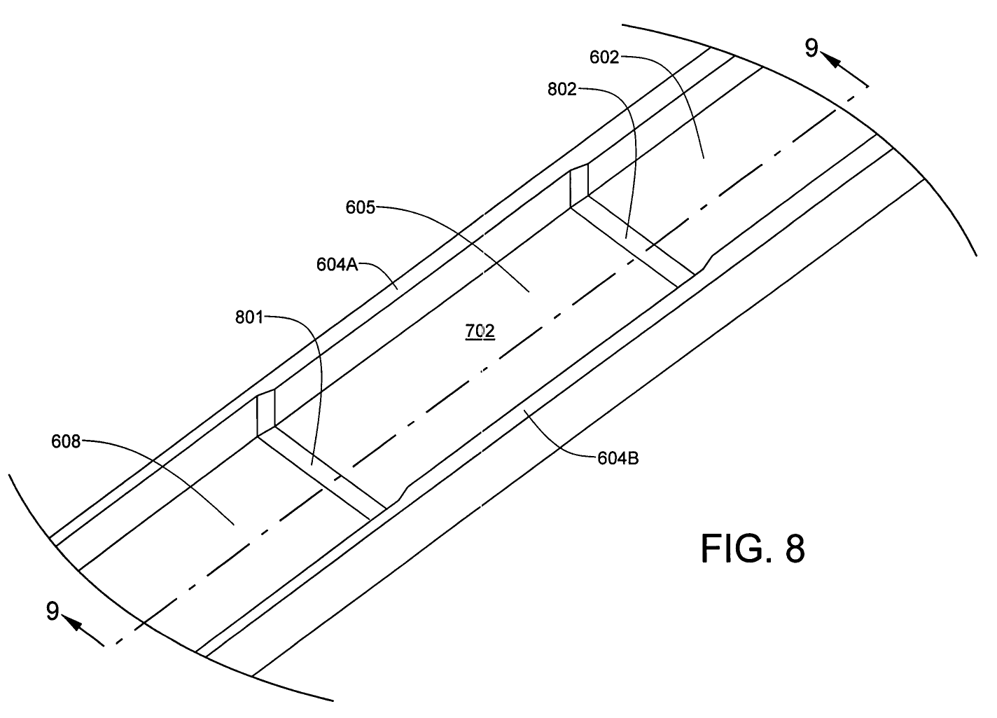

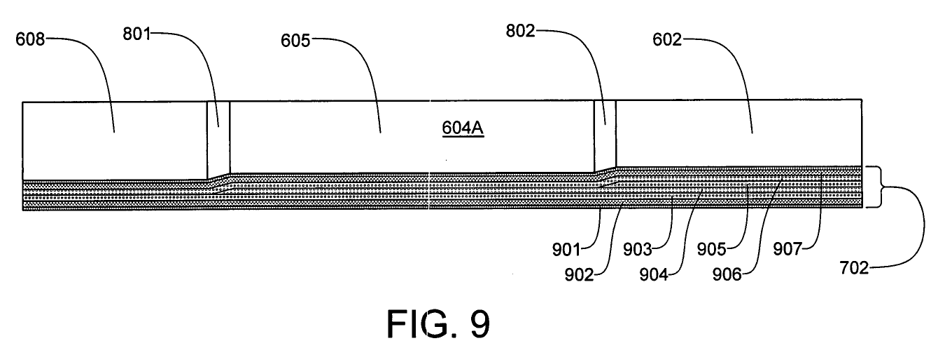

Referring now to FIG. 8, the top end 602 of rail 601 is reinforced in two steps, which correspond to the addition of discrete layers of structural fibers. In this view, it is apparent that each rail flange 604A and 604B transitions from a minimum standard thickness in a central region 701 to an intermediate thickness in region 702 to a maximum thickness in region 703. In FIG. 9, it will be apparent that the rail back 606 also transitions in thickness in two steps.

Referring now to FIG. 9, this cross sectional view shows that the rail base 704, like the rail flanges 604A and 604B, transitions from a minimum standard thickness in the central region 605 to an intermediate thickness in region 602 to a maximum thickness in region 603. For a presently preferred embodiment of the invention, the maximum thickness region 703 employs six layers of structural fibers 902, 903, 904, 905, 906 and 907, respectively. Layers 903, 904, 905 and 906 have a majority of structural fibers running in a 0-degree angle, longitudinal (i.e., lengthwise) direction within the rail. A minority of the fibers within layers 904, 904, 905 and 906 run generally perpendicularly to the 0-degree angle fibers. The structural fibers in layers 902 and 907 run in both a 45/225-degree-angle direction and a 135/315-degree-angle direction. A veil layer 901 of finely woven cotton/polyester cloth completely encapsulates the structural fiber layers and minimizes the problem of fiberglass slivers projecting through the surface of the rail. The transition regions 801 and 802 within the rail base 606 wrap upwardly to the rail flanges 604A and 604B.

It should be understood that the multi-layered preform of FIG. 9 is meant to be merely exemplary. Although woven fabrics are bidirectional and provide good strength in the direction of the yarn orientation, the tensile strength of woven fabrics is compromised to some degree because fibers are crimped as they pass over and under one another during the weaving process. These fibers tend to straighten under tensile loading, causing stree within the matrix system. Thus, the preferred preform for ladder rail manufacture is assembled using continuous-strand mat. A single mat having all desired fiber orientations may be employed for the regions of minimum cross-sectional area or multiple layers having different orientations may be used, as in the example of FIG. 9. In any case, additional layers are added to the preform where it must be strategically strengthened. An alternative to continuous-strand mat is multiaxial (nonwoven) fabric made with unidirectional fibers laid atop one another in different orientations and held together by through-the-thickness stitching or knitting. This process avoids the fiber crimp associated with woven fabrics because the fibers lie on top of one another, rather than crossing over and under. For multiaxial fabrics, the proportion of yarn in any direction can be selected at will.

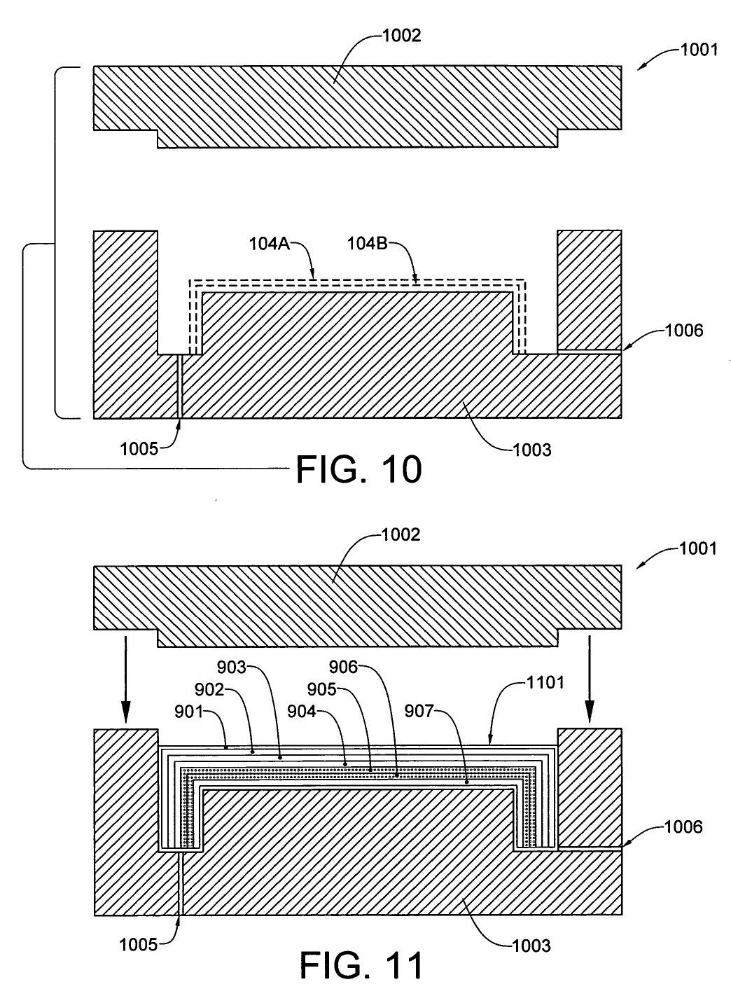

Referring now to FIG. 10, the cross-section of a closeable mold 1001 for fabricating a composite ladder rail in accordance with the present invention is shown. The closeable mold 1001 is a two-part mold, having lid portion 1002 and a cavity portion 1003. The cross-section of the mold shown in FIG. 10 is sized for maximum thickness. The dashed lines 1004A and 1004B show the respective shapes that the mold cavity would have for molding the minimum thickness regions and intermediate thickness regions of the rail. The cavity portion 1003 of mold 1001 is equipped with a resin inlet aperture 1005 and an air escape vent aperture 1006.

Referring now to FIG. 11, a structural fiber preform 1101, which in this region of the rail, consists of layers 902, 903, 904, 905, 906 and 907 and the encapsulating veil layer 901, is inserted within the mold cavity. The mold lid portion 1002 will be used to close the mold cavity portion 1003.

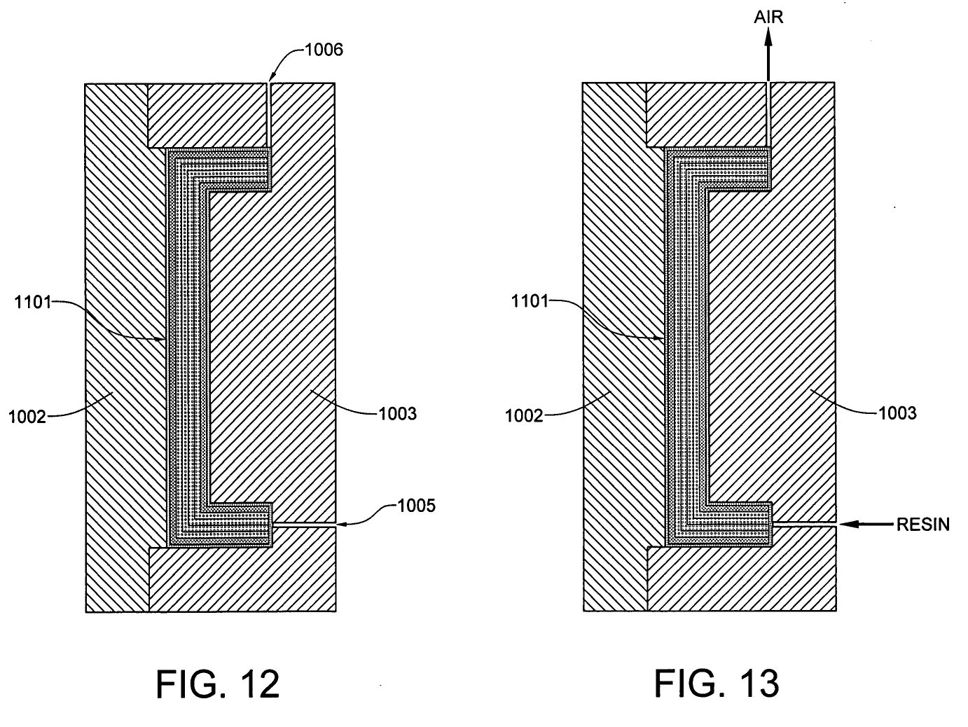

Referring now to FIG. 12, the mold 1001 has been closed and rotated so that the air escape vent aperture 1006 is at the top of the mold.

Referring now to FIG. 13, resin has been injected into the mold, saturating the structural fiber preform 1101. Once the resin attains green status, a solid but not-fully-cured state, the mold may be opened and the rail 601 removed from the mold cavity portion 1003.

Referring now to FIG. 14, a region of the mold 1001 for molding the minimum thickness regions of the composite ladder rail 1301 is shown. In this portion of the mold, the preform 1101 consists of the veil layer 901, two layers of intersecting diagonal structural fibers 902 and 907, and two 0/90 layers 903 and 906.

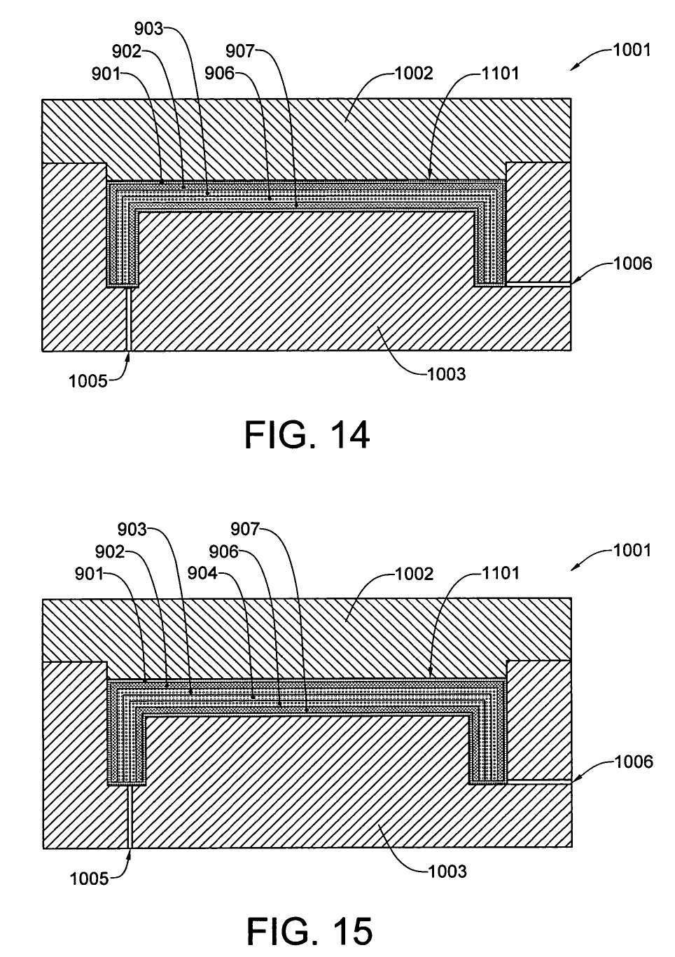

Referring now to FIG. 15, a region of the mold 1001 for molding the intermediate thickness regions of the composite ladder rail 1301 is shown. In this portion of the mold, the preform 1101 consists of the layers found in the preform section of FIG. 14 plus an additional 0/90 layer 904.

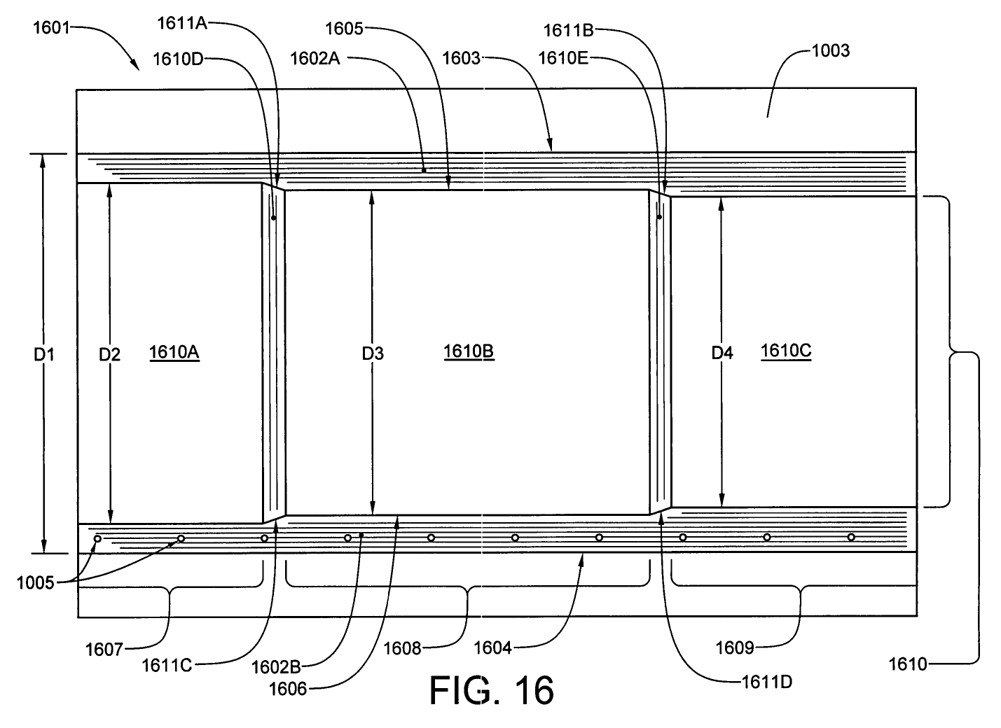

Referring now to FIG. 16, a section 1601 of the cavity portion 1003 of the mold 1001 used to fabricate the section of rail 601 shown in FIG. 9. It should be well understood that this is only a small portion of the entire mold 1001. A plurality of resin inlet apertures 1005, which are generally evenly spaced within the mold 1001, are clearly visible. The mold 1001 employs a plurality of generally evenly-spaced air escape vent apertures 1006, which are not shown in this view. The presently preferred embodiments of the composite rails fabricated in accordance with the present invention are of flattened U-shaped cross section, as can be seen in drawing FIGS. 2 through 9. Although the rails have been designed so that the outer surface of the U shape is constant and that only the interior shape changes, the invention may be practiced using the opposite technique of maintaining a constant shape on the inside of the U and varying the shape of the exterior shape. Although the mold 1001 of FIG. 16 employs the technique of using a constant outer surface and varying the inner surface, the opposite technique of having a constant inner surface and varying outer surface will also work. The flange recesses 1602A and 1602B are completely visible, with the distance D1 between the outer wall 1603 of flange recess 1602A and the outer wall 1604 of flange recess 1602B remaining constant over the entire length of the mold. The distance between the inner wall 1605 of flange recess 1602A and the inner wall 1606 of flange recess 1602B, on the other hand, varies from a maximum D2 in region 1607, where the flanges are thinnest to a minimum D4 in region 1609, where the flanges are thickest. In region 1608, the distance D3 is an intermediate value. The rail base surface mold surface 1610 of the mold cavity portion 1003 of mold 1001, which sculpts the inner surface of the rail base 704, is divided into three regions of different levels. Region 1610A is nearest the viewer, region 1610C is farthest from the viewer, and region 1610B is positioned at an intermediate distance from the viewer. It will be noted that there are also ramps 1610D and 1610E between the different levels of the rail base 1610 mold surface. It will also be noted that the transition regions 1611A, 1611B, 1611C and 1611D between regions of different levels for the rail flange recesses 1602A and 1602B are ramped, rather than abrupt, in order to reduce stresses at the transition region.

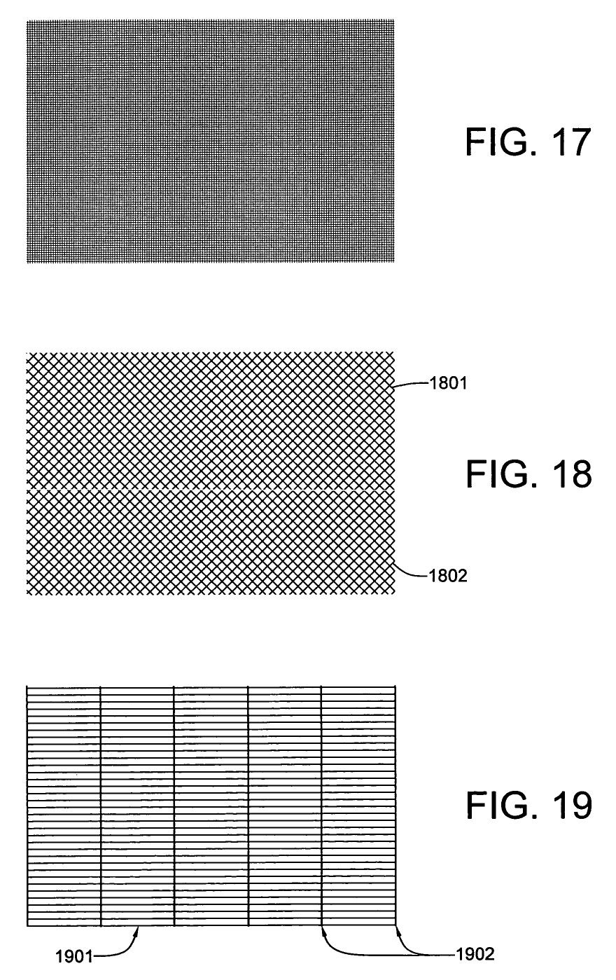

Referring now to FIG. 17, a swatch of the cotton or cotton/polyester veil fabric 1701 used for the veil layer 906, which encapsulates the structural fiber preform 1101, is shown. One way of encapsulating the structural fiber preform 1101 is to line the bottom and sides of the mold cavity with a sheet of veil fabric 1601, fold the edges of the veil fabric sheet to the sides, insert the preform, and fold the sides of the veil fabric sheet so that the edges overlap, and then close the mold.

Referring now to FIG. 18, a swatch of layer 902 is shown. Layer 902 has a first set of fibers 1801 which run in a 45/225-degree-angle direction, and a second set of fibers 1802 which run in a 135/315-degree-angle direction.

Referring now to FIG. 19, a swatch of 0/90 layer 901 is shown. Both the majority of 0-degree angle fibers 1901 and the minority of 90-degree angle fibers 1902 are shown.

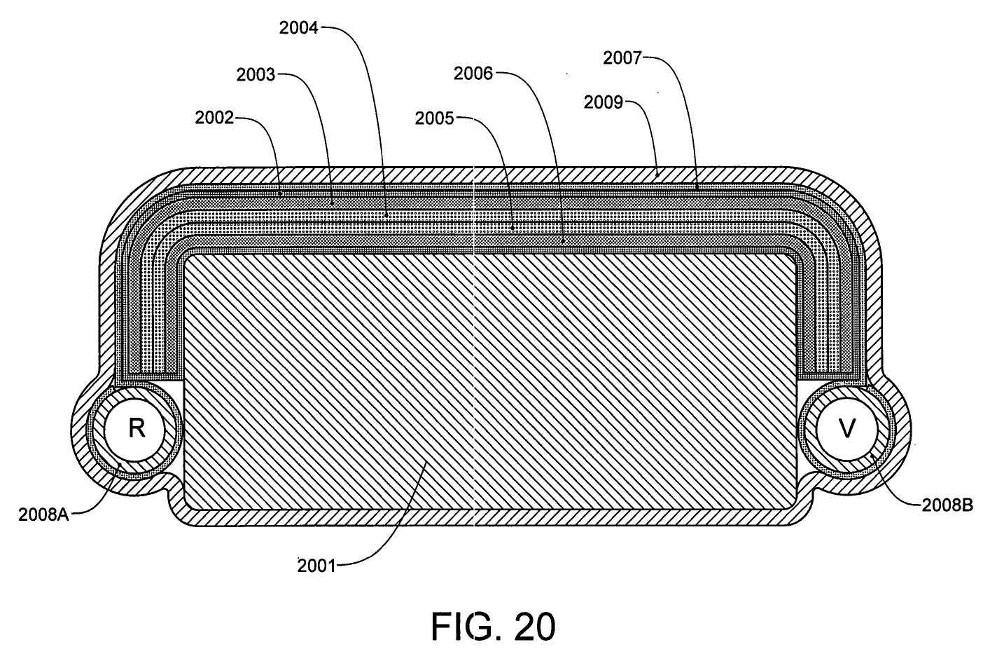

Referring now to FIG. 20, a rail may be fabricated in accordance with the present invention using an open mold and vacuum bagging to remove air from the preform. A mold block 2001 has been covered with a veil layer 2002 and four structrual fiber layers 2003, 2004, 2005 and 2006. The veil layer 2002 has been wrapped around the strucural fiber layers so that all structural fibers layers are wrapped within it. A porous mold release sheet 2007 is placed over the veil-wrapped structural fiber layers and each of the longitudinal edges of the mold release sheet 2007 is wrapped around a coil-spring tube 2008A and 2008B. Coil-spring tube 2008A has a central aperture labeled R, through which a thermosetting resin is injected after being mixed with a chemical initiator. The mold block 2001, the veil-wrapped structural fiber layers, the release sheet 2007 and the coil-spring tubes 2008A and 2008B are enclosed in an air impermeable bag 2009. A partial vacuum is applied to the aperture (which is labeled V) of coil-spring tube 2008B. The resin flows between the individual coils of the coil-spring tube 2008A, through the porous mold release sheet 2007, and through the veil wrapped strucutral fiber layup to the coil-spring tube 2008 to which the partial vacuum has been applied. The air-impermeable bag 2009 molds the outer surface of the ladder rail, which will be comprised of the veil, the structural fiber layers, and the resin, once it has cured.

A discussion of resin matrices is in order, as the invention may be implemented using a variety of different resin matrices. There are basically two kinds of polymeric resins: thermosetting and thermoplastic resins. Certain types of resins are available in both formulations.

Unsaturated polyester resins are extensively used because of their ease of handling, good balance of mechanical, electrical and chemical properties, and relatively low cost. Typically used in combination with glass fiber reinforcements, polyester resins are most commonly used in compression molding and resin transfer molding. Several basic types of polyester resins are available, including orthopolyester resins, isopolyester resins and terephthalic polyester resins, with the latter type exhibiting increased toughness. Vinyl ester resins provide enhanced performance, as compared with polyester resins, but at additional cost. However, vinyl ester resins do not match the performance of high-performance epoxy resins. For advanced composite matrices, the most common thermosetting resins are epoxies, phenolics, cyanate esters, bismaleimides (BMIs), and polyimides. Most commercial epoxies have a chemical structure based on the diglycidy ether of bisphenol A or creosol and/or phenolic novolacs. Phenolics are based on a combination of an aromatic alcohol and an aldehyde, such as phenol combined with formaldehyde. Phenolics are relatively inexpensive and have excellent flame-resistance and heat absorbtion properties. Cyanate esters are high in strength and toughness, absorb little moisture, and are excellent dielectrics. Bismaleimides and polyimide resins are used in high-temperature applications. Polybutadiene resins are excellent dielectrics, resistant to chemicals, and may be used in many applications as an alternative to expoxy resins. Polyethermide thermoset resins, which are derived form bisoxazolines and formaldehyde-free phenolic novolacs, are a cost-effective alternative to eepoxy and bismaleimide resins.

A non-exhaustive list of commodity thermoplastic resins includes polyethylene (PE), polyethylene terephthalate (PET), polybutylene terephthalate (PBT), polycarbonate (PC), acrylonitrile butadiene acrylate (ABS), polyamide (PA or nylon), and polypropylene (PP). High-performance thermoplastic resins, such as polyetheretherketone (PEEK), polyetherketone (PEK), polyamide-imide (PAI), polyarylsufone (PAS), polyetherimide (PEI), polyethersulfone (PES), polyphenylene sulfide (PPS) and liquid crystal polymer (LCP), withstand high temperatures, do not degrade whtn exposed to moisture, and provide exceptional impact resistance and vibrational damping. These characteristics make them useful for the manufacture of ladder rails.

Cyclic thermoplastic polyester has excellent fiber wetting characteristics and offers the properties of a thermoplastic and the processing features of a thermoset.

Both polyimide and polyurethane resins are available in both thermoset and thermoplastic formulations.

It should be apparent that a rail may be fabricated in accordance with the present invention for use with a folding step ladder. U.S. Pat. No. 4,718,518 to William E. Brown (the '518 patent) discloses a convertible step ladder having a two-piece back section. This patent is hereby also incorporated by reference into the present application. A lower piece of the back section is removable so that the step ladder can be used on stairs as well as on a flat surface. Composite or fiberglass rails may be molded in accordance with the present invention for use with either a conventional step ladder having a one-piece back section or for a convertible step ladder. The rails may be reinforced in appropriate locations, such as the foot of the rail, the top of the rail where it is hinged, or an attachment region for a removable lower piece of the back section. It should be understood that different types of steps may be incorporated into any of the types of ladders discussed herein. Various method for attaching steps to the rails may also be used. For example, step may be swedged or welded to a bracket which is attached with rivets or screws to the rail. Alternatively, a hole may be cut or stamped in the rail, and an end of the step inserted within the hold and held in place with swedged retaining rings. The types of steps to be used and the method of their attachment to the rail fall largely outside the scope of this disclosure, as may types of steps and many methods of step-to-rail attachment are well known in the art and may be applied to the art of ladder manufacture using the rails of the present invention. That is to say that the practice of the present invention is not limited to any particular type of step or any particular method of step-to-rail attachment.

It should also be evident that the preforms used to make the rails of the present invention may be completely formed prior to their insertion in the mold, or they may be constructed by laying up multiple layers, which may even be done manually within the mold.

Although only several embodiments of the invention has been shown and described, it will be obvious to those having ordinary skill in the art that changes and modifications may be made thereto without departing from the scope and the spirit of the invention as hereinafter claimed.

What is claimed is:

1. A ladder comprising:
at least one pair of composite rails, each rail comprising a preform of structural fibers embedded in a solidified polymeric material, and having non-uniform cross-sectional area throughout its length; and
a plurality of rungs coupling each of said pairs together.

2. The ladder of claim 1, wherein there exists a direct correlation between the cross-sectional area at a particular location along the length of a rail and the number of structural fibers embedded within the rail at the particular location.

3. The ladder of claim 2, wherein there exists a direct correlation between the number of fibers present at a particular location along the length of a rail and the strength of that location relative to other locations along the length of the rail.

4. The ladder of claim 1, which is configured as a non-self-supporting extension ladder having a first pair of parallel composite rails forming a base section and a second pair of parallel composite rails forming a fly section.

5. The ladder of claim 4, which further comprises an intermediate section, having a third pair of parallel composite rails, between said base section and said fly section.

6. The ladder of claim 1, wherein each of said composite rails is a molded unit fabricated using a molding process other than pultrusion.

7. The ladder of claim 1, which comprises a first pair of composite rails forming a first section, and a second pair of composite rails forming a second section, said first and second section hinged together so that, when said first and second sections are hingeably positioned to form an acute angle, the ladder is configurable as a self-supporting step ladder, and when said first and second sections are hingeably positioned to form a straight angle, the ladder is configurable as a non-self-supporting, non-adjustable extension ladder.

8. The ladder of claim 1, wherein a majority of said structural fibers run in a longitudinal direction within each rail.

9. The ladder of claim 8, wherein a minority of said structural fibers is divided into at least two groups, with fibers of a first group being oriented perpendicularly to said majority of structural fibers, and with fibers of a second group being oriented obliquely to said majority of structural fibers.

10. The ladder of claim 1, wherein regions of a rail having lesser cross-sectional area taper to regions of the rail having greater cross-sectional area.

11. The ladder of claim 1, wherein said structural fibers are selected from the group consisting of type E glass, type S glass, type S2 glass, type A glass, type C glass, quartz, poly p-phenylene-2,6-bezobisoxazole (PBO), basalt, boron, aramid, ultra-high-molecular-weight polyethylene, carbon, graphite and hybrids.

12. The ladder of claim 1, wherein said solidified polymeric material is a cured thermoset resin selected from the group consisting of polyester, vinyl ester, epoxy, phenolic, cyanate ester, bismaleimides (BMIs), and polyimide resins.

13. The ladder of claim 1, wherein said solidified polymeric material is a thermoplastic selected from the group consisting of polyethylene, polyethylene terephthalate, polybutylene terephthalate, polycarbonate, acrylonitrile butadiene acrylate, polyamide, polypropylene, polyetheretherketone, polyetherketone, polyamideimide, polyarylsufone, polyetherimide, polyethersulfone, polyphenylene sulfide and liquid crystal polymer.

14. An extension ladder comprising:
a first pair of parallel composite rails, each of which is supplementally reinforced in regions subjected to greater stress during usage;
a first set of rungs coupling together said first pair of parallel composite rails to form a base section;
a second pair of parallel composite rails, each of which is supplementally reinforced in regions subjected to greater stress during usage;
a second set of rungs coupling together said second pair of parallel composite rails to form a fly section which is slidable within said base section; and
a pair of rung lock mechanisms, each rung lock mechanism being secured to a fly section composite rail and being lockable to any a plurality of rungs belonging to said first set, thereby providing adjustability of length of the extension ladder.

15. The extension ladder of claim 14, wherein said stress during usage may be the result of torque, shear forces, flex forces, or abusive impact forces.

16. The ladder of claim 14, wherein each of said rails comprises a structural fiber preform embedded in a polymeric material selected from the group consisting of initiator-cured polymeric resins and thermoplastic compounds.

17. The ladder of claim 16, wherein said structural fiber preform contains structural fibers selected from the group consisting of E glass, type S glass, type S2 glass, type A glass, type C glass, quartz, poly p-phenylene-2,6-bezobisoxazole (PBO), basalt, boron, aramid, ultra-high-molecular-weight polyethylene, carbon, graphite and hybrids.

18. The ladder of claim 16, wherein each structural fiber preform has increased structural fiber counts in regions subjected to greater stress during usage.

19. The ladder of claim 14, wherein supplementally reinforced regions of a rail have a greater cross-sectional area than regions of the same rail which are not supplementally reinforced.

20. The ladder of claim 17, wherein a majority of said structural fibers run lengthwise through each rail.

21. The ladder of claim 20, wherein a minority of said structural fibers is divided into at least two groups, with fibers of a first group running perpendicular to said majority of structural fibers, and with fibers of a second group running oblique to said majority of structural fibers.

22. The ladder of claim 21, wherein regions of a rail having lesser cross-sectional area taper to regions of the rail having greater cross-sectional area, thereby providing a transition between regions of greater and lesser cross-sectional area in order to more evenly distribute stresses within the rail.
